(19) United States
(12) Patent Application Publication
(10) Pub. No.: US 2007/0106698 A1
(43) Pub. Date: May 10, 2007

(54) Server based automatically updating address book

(75) Inventors: Paul A. Elliott, Woodinville, WA (US); DeEtte M. Day, Seattle, WA (US); Jason C. Fluegel, Seattle, WA (US); Steven D. Kafka, Mountain View, CA (US); Pak Ko, Kirkland, WA (US); Stephen P. Rosato, Woodinville, WA (US); Suresh Sunku, Issaquah, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/267,973

(22) Filed: Nov. 7, 2005

(51) Int. Cl. G06F 17/30

(52) U.S. Cl. 707/200

(57) ABSTRACT

A method is disclosed for address book owners to link to a publisher's contact information profile, and establish an automatic updates relationship with the publisher. Upon establishing this relationship, when a publisher modifies his or her profile to reflect updated contact information, the publisher's updated profile information may then automatically be published to an address book owner's address book so that the address book owner's contact for the publisher is automatically updated to reflect the new information in the profile. Thus, the publisher's contact in the address book owner's address book may be automatically updated as a result of a publisher updating his or her profile, and without any action on the part of the address book owner.

### BACKGROUND

1. Field of the Present System

The present system is directed to methods for automatically updating contact information.

2. Description of the Related Art

Present technology offers a wide variety of devices and applications for people to stay in constant contact with one another. People have work phones, home phones, mobile phones, facsimile numbers, pagers, multiple email accounts, instant messaging accounts, business addresses and home addresses to name a few sources of contact information. There are currently several program applications which allow users to keep track of their contact information, such as for example, Hotmail® web-based email service and Outlook® messaging and collaboration client, both from Microsoft Corporation, Redmond, Wash. The ease with which such application programs allow users to store contact information often results in users having large numbers of contacts stored.

One difficulty in managing large amounts of contact information in such application programs is that each individual's contact information changes regularly. People move, change phones, change jobs, and it is difficult to keep an address book current. Unless the user is diligent in updating new contact information as it comes in, a user often winds up combing through old emails, voice mails or messages for individuals' new contact information. Even where a user is diligent, the task of updating information can be quite time consuming. Similarly, when an individual moves, changes jobs, etc., the task of sending out the new contact information to all of the user's contacts can be daunting, especially if that user's contact information is not up-to-date.

### SUMMARY

Embodiments of the present system in general relate to methods for automatically updating contact information. A profile service allows individuals, referred to herein as publishers, to set up a profile which may be stored on a database within a service provider. A publisher's profile contains the contact information such as personal contact information and professional contact information. A unified service provider address book further contains individual address books owned and operated by registered service provider users. In accordance with the present system, the service provider system includes an auto update engine for automatically updating contact information appearing in the unified service provider address book once the publisher makes a change to his or her contact information in the publisher's profile.

In embodiments, the auto update engine runs within the service provider system, for example within a database server. Running the automatic update feature of the present system from the server side provides advantages over running the feature from the client side in that there are no client software downloads or installations required, and there is no requirement of a “smart” client that can manage the automatic update process.

Once a publisher sets up a profile, a gleam may be added to the publisher's contact as it appears in address books of address book owners within the service provider network. The address book owners may then make a request of the publisher to receive automatic updates when the publisher's contact information changes. If the publisher accepts an address book owner's request, then when the publisher makes a change to his or her contact information in his or her profile, that change will automatically be written into the publisher's contact appearing the address book owner's address book.

### DESCRIPTION OF THE DRAWINGS

FIG. 1 is a block diagram of a system for implementing one embodiment of the present system.

FIGS. 2A and 2B are flowcharts of the steps performed in embodiments of the present system to enroll a publisher and set up the publisher's profile.

FIG. 3 is a flowchart of the steps performed in embodiments of the present system to link an address book owner to automatically updating information from the publisher's profile.

FIG. 4 is a flowchart of the steps performed in an alternative embodiment of the present system to link an address book owner to automatically updating information from a publisher's profile.

FIG. 5 is a flowchart of the steps performed in embodiments of the present system for a publisher to manage which address book owners receive the publisher's automatically updating profile information.

FIG. 6 is a flowchart of the steps performed in embodiments of the present system for changing a publisher's profile information.

FIG. 7 is a flowchart for the steps performed in embodiments of the present system for changing permissions for access to a publisher's profile information.

FIG. 8 is a block diagram of computer hardware suitable for implementing embodiments of the present system.

### DETAILED DESCRIPTION

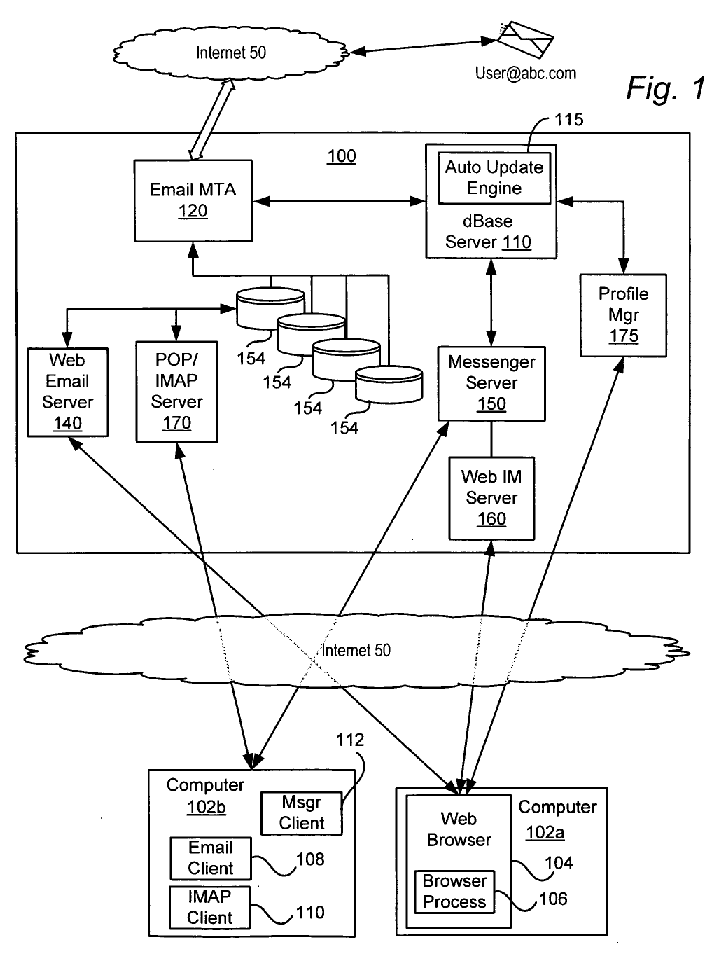

Embodiments of the present system will now be described with reference to FIGS. 1-8, which in general relate to methods for automatically updating contact information. In such embodiments, a profile service allows individuals, referred to herein as publishers, to set up a profile which may be stored on a database within the service provider. The publisher's profile contains the publisher's contact information, which may be subdivided into sub-profiles for the publisher's personal contact information, professional contact information and other categories.

Separate and independent from publishers' profiles, a unified address book service further contains individual address books owned and operated by registered service users. These users are referred to herein as address book owners, or AB owners. It is understood that the terms “address book owner” and “AB owner” may be broader than just service users and may further include owners of address books outside of the service provider in embodiments of the present system. An AB owner may have within his or her address book a contact for the publisher including the publisher's contact information.

In accordance with the present system, a publisher may allow AB owners to link to the publisher's profile and establish an automatic updates relationship with the publisher. Thereafter, when a publisher's contact information changes, the publisher may modify his or her profile to reflect the changes. The publisher's updated profile information may then automatically be published, or pushed, to AB owners' address books having a contact record for the publisher, and the AB owners' contact record for the publisher may be automatically updated to reflect the new information in the profile. Thus, the publisher's contact record in the AB owners' address books may be automatically updated as a result of a publisher updating his or her profile, and without any additional action on the part of the AB owners.

Referring to the block diagram of FIG. 1, there is shown an embodiment of a service provider system 100 which may be operated by an enterprise service provider such as MSN®, Yahoo®, AOL®, or other online service providers. The service provider system 100 may support different application interfaces allowing networked communication. For example, where service provider system 100 is that of the MSN® network, the system 100 may support an email application program such as MSN Hotmail®, as well as an instant messaging application program such as MSN Messenger.

System 100 is comprised of a plurality of computing devices maintained by the enterprise service provider. In one embodiment, it may consist, for example, of a message transfer agent (MTA) 120, a user information database server 110, user mail storage units 154, an email server 140, a POP/IMAP server 170, a messaging server 150 and a web integrated messaging server 160.

System 100 allows users, who may be both publishers and address book owners as explained hereinafter, operating processing devices 102a and 102b to access email, messages, and other data, and forward outbound messages and messaging information to users within the domain of system 100 and domains accessible via the Internet 50. Users may connect to the system 100 via any number of public or private networks including the Internet. The user database server 110 stores information allowing users to authenticate themselves to system 100 to access their email and Internet messaging.

In embodiments, the database server 110 may further house a unified address book for all registered users, including contact information. This contact information is available to registered users across a variety of user application programs, such as email, instant messaging, etc. The unified address book may include profiles for each registered user, as explained in greater detail hereinafter.

The database server 110 may further include an auto update engine 115 as explained hereinafter for managing the automatic update of changed contact information for subscribing address book owners. The database server 110 further allows other servers in the system to direct mail and messages within the system to storage locations on storage units 154.

Email server 140 may comprise a web server which provides an email interface to a web browser 108 which institutes a browser process 106 on the user computer 102a. Email server 140 can render email data from the data storage units to a user using computer 102a to access the email system 100. Likewise POP/IMAP server 170 can provide email data to a POP e-mail client 118 or an IMAP client 110 on user computer 102b. Messenger server 150 can provide information directly to a messenger client 112 or via a web Internet messaging server 160 to web based messenger clients operating in a browser process 106 and web browser 104.

Inbound and outbound email messages from users on computers 102a and 102b are sent and received in system 100 via the MTA 120. Email MTA 120 generally uses SMTP to route mail via the Internet 50 to users at other Internet accessible domains. E-mail MTA 120 is a front-end server to which emails 190 transmitted via the Internet to system 100 are directed and which forward messages from users of the messaging system 100 to other users on the Internet 50. It should be understood that as a web based enterprise service provider environment, a number of email MTAs 120 will be present.

The user database server 110 is a data store of user account and storage location information for each of the users having a user account or email address within system 100. As indicated, database server 110 further includes an auto update engine 115 for managing the automatic update of changed contact information for subscribing address book owners. In particular, the auto update engine 115 manages a subscription process, whereby an AB owner subscribes to automatically receive updated contact information when one of their contacts changes their information stored in their profile.

In order to manage this process, the auto update engine 115 generates and modifies a status flag which is stored in the contact information in the AB owner's contacts. The status flag, referred to herein as “ContactType,” may be set to the following states for a contact in the AB owner's contacts:
“Regular”—when there is no automatic update relationship between the AB owner and that contact;
“Live”—when there is an automatic update relationship between the AB owner and that contact (i.e., the AB owner will receive updated information when that contact updates his or her profile) and at least one update has been received from the publisher's profile;
“LivePending”—when an AB owner has requested to receive automatic updates for a contact, and is waiting for authorization by the contact;
“LiveRejected”—when the AB owner has requested to receive updated contact information from that contact, but that contact has denied that request; and
“LiveDropped”—when there was an automatic update relationship between the AB owner and that contact, but the contact has rescinded that relationship.

The auto update engine 115 also generates and modifies a reverse list for each stored profile, which reverse list is stored in database server 110 in association with each stored profile. The reverse list is a list of all AB owners who receive automatic updates when a publisher changes their contact information in their stored profile. An AB owner is added to a publisher's reverse list when the AB owner receives automatic updates from that publisher, and an AB owner is removed from a publisher's reverse list when the AB owner no longer receives automatic updates from that publisher.

The auto update engine 115 also manages the sending, or “fanning out,” of changed contact information to a subscribing AB owner when a contact in the AB owner's contacts changes their stored profile information.

The subscription and fanning out processes managed by the auto update engine 115 are explained in greater detail hereinafter. In embodiments, the auto update engine runs within the service provider system 100, for example within database server 110. Running the automatic update feature of the present system at the server level provides advantages over running the feature from the client side in that there are no client software downloads or installations required, and there is no requirement of a “smart” client that can manage the automatic update process. However, it is understood that the automatic update features of the present system as described herein may be run from the client side in alternative embodiments.

Storage units 154 may essentially be large disk arrays storing user message information. The system may include additional components not shown here for convenience in understanding the present system.

The service provider system 100 may further include a profile manager 175 allowing publishers to initially set up and subsequently edit their profiles. The profile manager may be a web server which, when accessed by a publisher, presents the publisher with an interactive web page over their browser 104 allowing the publisher to input and then save the information for their profile. Publishers may access the profile manager 175 via the Internet or other network. After a profile is set up, the publisher may connect to the profile manager via their web browser to access and update their profiles. As would be understood, the profile manager need not be a web server, and may be accessed by clients other than a web browser, in alternative embodiments.

With the above service provider system, a stored contact in an AB owner's address book may be accessible from and available to the AB owner over any of a variety of application interfaces, such as for example an instant messaging application program, an email application program and/or a weblog reader application program. An AB owner may add a new contact to his or her address book when in one of the above-named application interfaces, or elsewhere, as is known in the art. In particular, when in an application program allowing the addition of a new contact, upon selecting the proper option as from a tool bar or drop down menu, the user may be presented with a window over the user's graphical user interface prompting the user to add information about the new contact. Such information may include name, address, company, telephone numbers, email addresses, website, the contact's screen name, etc. This stored contact information may be automatically updated as explained hereinafter.

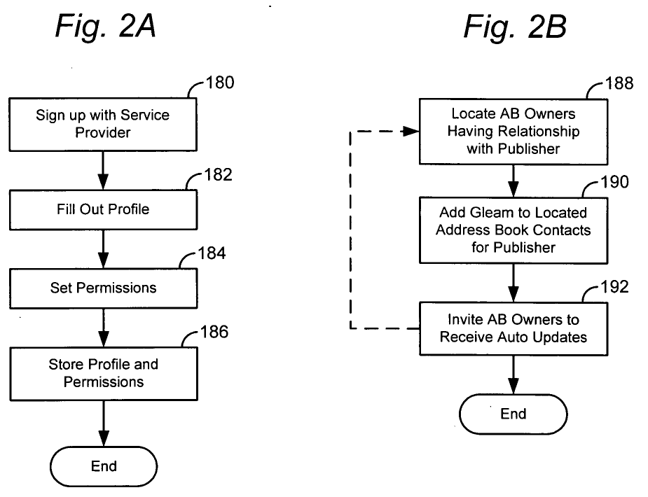

Referring now to FIG. 2A, there is shown a flowchart for the steps performed by an embodiment of the present system for a publisher to set up a profile on the service provider. In step 180, a publisher can sign up with a service provider and obtain unique log-on credentials, such as for example, a unique identifier and password. In step 182, the publisher may be presented with a webpage from the profile manager 175 allowing the user to fill out a profile with the user's contact information. The type of information which may be stored in the publisher's profile is known, but in embodiments, may include a plurality of sub-profiles which, by way of example only, may be categories such as:
General—photo, name, age, occupation, interests;
Professional—business contact information;
Personal—personal contact information;
Social—relationships, interests, pets, religion, ethnicity, politics;
Dating—physical characteristics, likes, dislikes;
Gaming—Xbox® gamertag, owned games, favorites;
Career—job, expertise, resume;
Education—schools, colleges, degrees.
   It is understood that additional and/or alternative sub-profiles and fields within the various sub-profiles may be provided.

In a step 184, the publisher may set permissions for some or all of the sub-profiles. The permissions allow a publisher to set which AB owners have permission to view the publisher's profile information, and which information within the profile they have permission to view. In embodiments, the fields within a given sub-profile are not independently permissioned, but instead the sub-profile receives a set permission for the entire sub-profile. It is understood that the individual fields within a sub-profile may be independently permissioned in alternative embodiments. A publisher may set permissions on an individual by individual basis, or the publisher may group individuals into permission groups so that the set permissions apply to anyone in the group or thereafter added to the group. Known groups for which permissions may be set include the public in general, friends, friends of friends, Messenger Contacts, individuals, etc. The different groups, and those who are admitted into the different groups, may be defined by the publisher via the profile manager 175. Only those groups and/or individuals who have been granted permission by the publisher to view a particular sub-profile will be able to access and view that sub-profile.

In step 186, the information contained in a publisher's profile, and the permissions set for a publisher's profile, are stored by the profile manager 175 in database server 110, though this information may be resident outside of the service provider in alternative embodiments.

Referring now to FIG. 2B, once a publisher has established a profile, either after signup or at a later time, the auto update engine 115 locates AB owners having a relationship with publisher in step 188. For example, other application interfaces, such as MSN Spaces and MSN Messenger, make use of a reverse list indicating a relationship between individuals. Thus, when a publisher creates a profile as described above, the publisher may already have a reverse list of AB owners. Upon creation of a profile, AB owners on the publisher's reverse list may have their contact for the publisher automatically populated with the data from the profile and activated for updates from the profile as they occur. Likewise, if an AB owner is on the publisher's reverse list, if and when that AB owner creates a contact for the publisher, that contact for the publisher may be automatically populated with the data from the profile and activated for updates from the profile as they occur.

In addition to or instead of locating AB owners having a relationship with the publisher, the auto update engine 115 may locate AB owners by performing a matching operation to locate contacts for the publisher in AB owners' address books within the service provider system 100. The auto update engine may use different matching criteria to identify the publisher's contacts across the address books in the service provider network, including for example the publisher's email address. Other unique identifiers for the publisher may be used instead of or in addition to the publisher's email address in alternative embodiments.

As a result of a contact having a relationship with a publisher when the publisher establishes his or her profile, or as a result of identifying a publisher in an AB owner's address book, a visual indicator, or “gleam,” may be added to the AB owner's contact for the publisher in step 190. The gleam may represent to the AB owner that the publisher has set up a profile, and the AB owner may link to that profile and set up an automatic updates relationship. The gleam may also be a hyperlink which, if clicked, presents a subscription webpage to the AB owner from a web server in the service provider system 100. The subscription webpage explains the automatic updates feature and gives the AB owner the option to subscribe to receive automatic updates for that publisher and others. The AB owner may also be given the option at that point to create their own profile for automatically updating their contact in other AB owners' address books. The gleam may be any of various highlights, glyphs, or other marks designated to indicate that an AB owner's contact information for the publisher may be automatically updated.

In addition to or instead of a gleam, a pop-up window may be presented to the AB owner, either at the time the AB owner's contact is matched to the publisher's profile, or at the time the AB owner next views the publisher's contact in their address book. The pop-up window may explain to the AB owner that the publisher has set up a profile, and the AB owner may link to that profile and set up an automatic updates relationship. The pop-up window may also be, or include, a hyperlink which, if clicked, presents the AB owner with the above-described webpage explaining the automatic updates feature and giving the AB owner the option to subscribe to receive automatic updates for that contact and others.

In embodiments, after a publisher has set up his or her profile, the present system may allow the publisher to invite AB owners to receive automatic updates for the AB owners' contact information for that publisher in a step 192. This may be accomplished by automatically generating and sending out an email to all such invitees. The invite may alternatively go out manually over any mode of communication selected by the publisher. The auto update engine may keep track of invitees, so that they may be enrolled in the auto updates relationship with the publisher when and if the invitee accepts the invitation by, for example, replying to the email and subscribing. This feature is explained in greater detail hereinafter. Where the invite is manually sent by the publisher, the publisher may indicate to the profile manager that an invite was sent and to whom. The steps 188 through 192 may be repeated by the system to identify new relationships between a publisher and an AB owner as indicated by the dashed arrow in FIG. 2B.

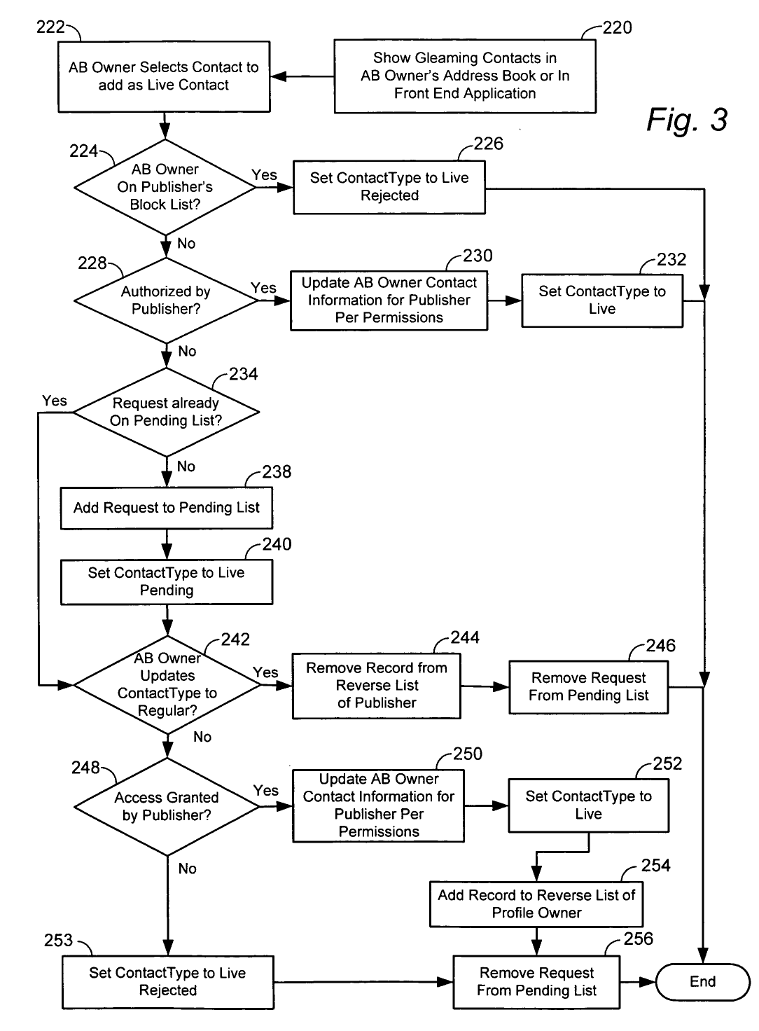

Referring now to FIG. 3, embodiments of the present system allow AB owners to request to receive automatic contact information updates for one or more of their contacts that have set up profiles. In embodiments, the AB owners may belong to the service provider system 100, but it is contemplated that the AB owners need not belong to the service provider system in alternative embodiments. As described below, an AB owner will in general make a request on the publisher to automatically receive the publisher's contact information as it is periodically updated. Once the request is made by the AB owner, it must be accepted by the publisher.

As indicated above, when a publisher creates a profile, contacts for that publisher in an AB owner's address book may gleam (or provide some other highlight or visual indication). An AB owner may receive notification that one of their contacts has a profile, and may be automatically updated, from a wide variety of different application interfaces. Step 220 in FIG. 3 describes two such scenarios. In one example, described above, an AB owner may be viewing contacts in their address book, and one or more contacts in the address book may gleam.

A second option shown in step 220 is for an AB owner to be notified that one of their contacts has a profile, and may be automatically updated, from a variety of other front end application interface, such as for example, an instant messaging application program, an email application program and/or a weblog reader application program. When a publisher's contact or other identification appears in one of these application programs, the contact may gleam. As described above, and the AB owner may be given the opportunity to click on a link associated with the gleam and/or contact through which link the AB owner may subscribe to receive automatic updates for that contact and others. In addition to viewing a gleaming contact in a front end application interface, an AB owner may receive notification in a pop-up window when using the front end application interface.

In general, any application interface which presents contact information from the service provider unified address book may include gleams for a contact allowing an AB owner to subscribe to an automatically updating relationship with the publisher identified by that contact. In a further embodiment (not shown in step 220, FIG. 3), an AB owner may have access to, and may be viewing, a publisher's profile. The user interface may include a link from the profile allowing the AB owner to request to receive automatic updates from that publisher profile.

In step 222, an AB owner selects a contact they would like to automatically update. If the AB owner has not previously subscribed to receive automatic updates, the AB owner is presented with a subscription webpage as described above allowing the AB owner to subscribe to the automatic updates feature. If the AB owner has already subscribed, the AB owner is not presented with the subscription webpage.

The present system then checks in step 224 whether the AB owner is on the publisher's block list. In particular, the publisher is given the option to block automatic update requests from address books owners, for example where the publisher does not want to send an AB owner his or her updates and does not want communications from the AB owner. If the AB owner in step 224 is on the publisher's block list, the status of ContactType is set to LiveRejected in step 226, and no further steps are taken to set up the automatically updating feature between the publisher and that AB owner.

If the AB owner is not on the publisher's block list, the present system next checks in a step 228 whether the AB owner is already authorized to receive automatic updates from the publisher. If so, the AB owner's contacts are updated in step 230 with the publisher's current information per the publisher's permissions for that AB owner. Namely, the auto updates engine first retrieves the permissions for that AB owner as set by the publisher, and then updates the AB owner's contact information for the publisher in accordance with those permissions. The ContactType is also set to Live in step 232.

While a profile may include a wide variety of sub-profiles as described above, in embodiments of the present system, only the fields from the publisher's professional and/or personal sub-profiles are subject to being automatically updated in the AB owner's contacts in embodiments of the present system. It is understood however, that a wide variety of other sub-profiles may be automatically updated in an AB owner's contacts in alternative embodiments.

If the AB owner is not yet authorized by the publisher in step 228, the present system checks in step 234 whether the AB owner has already made a request to join the automatic updates for the publisher. The pending list is a list stored in the database server 110 or elsewhere of all requests made to receive automatic updates for that publisher. If the AB owner is not yet on the publisher's request pending list, the request is added to the pending list in step 238, and the status of ContactType is set to LivePending in step 240. If the AB owner's request is already on the pending list, step 238 and 240 are skipped.

Either before a request has been acted upon by a publisher, or any time after a request for automatic updates has been accepted, an AB owner may cancel the automatic updates for a publisher. In step 242, the system checks whether the AB owner no longer wishes to receive automatic updates from the publisher. If so, the status of ContactType is set to Regular. Additionally (if applicable), the AB owner's record is removed from the publisher's reverse list in step 244, and (if applicable) the AB owner's request is removed from the pending list in step 246. As described above, the reverse list is a list of all AB owners who have subscribed to receive that particular publisher's automatically updating contact information. Similarly, if the AB owner at any time, no longer wishes to receive automatic updates, then they only update the corresponding contact in their address book, and ABCH will automatically remove the AB owner from the Publishers Reverse and (if applicable) Pending list.

Assuming the AB owner does not withdraw his or her request to receive automatic updates from the publisher, the system next checks in step 248 whether access to automatic updates has been granted by the publisher. If access is denied by the publisher, then the status of ContactType is set to LiveRejected in step 253. The AB owner's request is removed from the pending list in step 256. No automatic updates will then be received by the AB owner for that contact.

If, on the other hand, the AB owner's request is granted by the publisher in step 248, the AB owner's contact for the publisher is updated in step 250 per the permissions set for that AB owner. The status of ContactType is set to Live in step 252, a record for the AB owner is added to the reverse list for the publisher in step 254, and the AB owner's request is removed from the pending list in step 256. While an AB owner is waiting for a response to his or her request to receive automatic updates, the status of ContactType remains in LivePending until the request is either granted or denied by the owner in step 248.

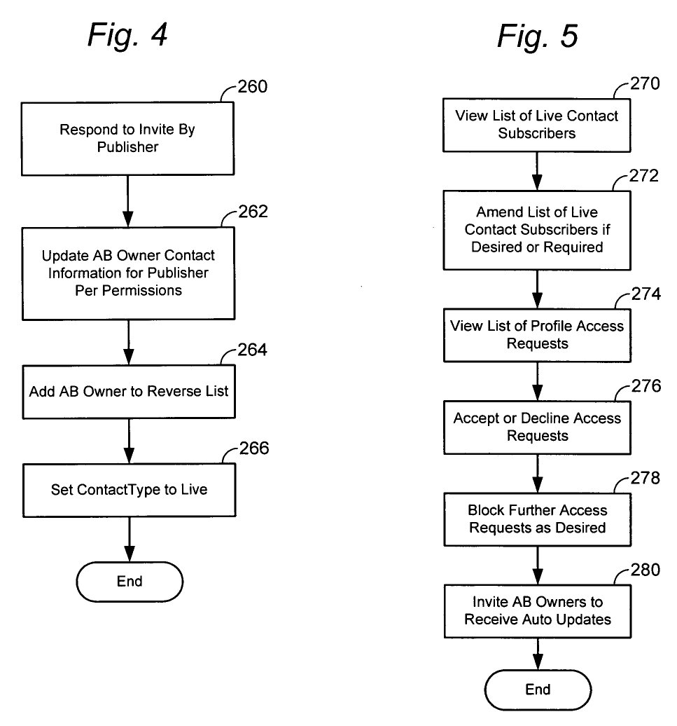

FIG. 4 illustrates the special situation where an AB owner is responding to a specific invitation from the publisher to receive the publisher's automatically updating contact information, as described above with respect to step 192, FIG. 2B. The AB owner may respond to the invitation from the publisher in step 260. Upon confirmation by the auto update engine 115 that the AB owner was in fact invited to receive the automatically updating contact information, the auto update engine may update the AB owner's contact information for the publisher (step 262), per the permissions set by the publisher for the AB owner. Namely, the auto updates engine first retrieves the permissions for that AB owner as set by the publisher, and then updates the AB owner's contact information for the publisher in accordance with those permissions.

Once an AB owner accepts a publisher's invitation to receive the publisher's automatically updating contact information, the AB owner may be added to the reverse list stored in the database server 110 in a step 264. Additionally, once an AB owner's contact information has been updated in step 262, the ContactType flag for that contact may be set to Live in the AB owner's address book in step 266.

Referring now to FIG. 5, after creation of a profile, a publisher may manage the profile and his or her relationships with AB owners. The publisher may view a list of AB owners who receive automatic updates from him or her (if any) in a step 270. This list is the reverse list for that publisher. A publisher may amend the list of AB owners that are automatically updated with the publisher's contact information in step 272. In embodiments, a publisher may have a maximum number of AB owners that are automatically updated. Therefore, the publisher may choose to remove an AB owner in step 272 so that he or she can add another AB owner. There may be no such quotas in alternative embodiments.

In a step 274, a publisher may view a list of pending requests to provide read access to their profiles. An AB owner requesting access may or may not include a wish to obtain automatic updates. If the AB owner is also added to the publisher's profile reverse list, then the act of granting read access, will also grant automatic updates. The publisher may accept or decline those access requests in step 276. When accepting access requests, the publisher will also specify which individual sub-profiles the AB owner can view or receive automatic updates from. In addition to simply declining an access request, a publisher may block further access requests from particular AB owners at the publisher's discretion in step 278 as described above. The act of declining access, will also remove the AB owner from the reverse list if they had also expected to receive automatic updates.

In step 280, a publisher may be given the option to invite AB owners to receive automatic updates from the publisher, as described above with respect to step 192, FIG. 2B. An invite from publisher to subscriber could be (a) immediate, a popup or a gleam if the user is currently logged into the system or (b) not-immediate when subscriber logins to the system next time or using e-mail

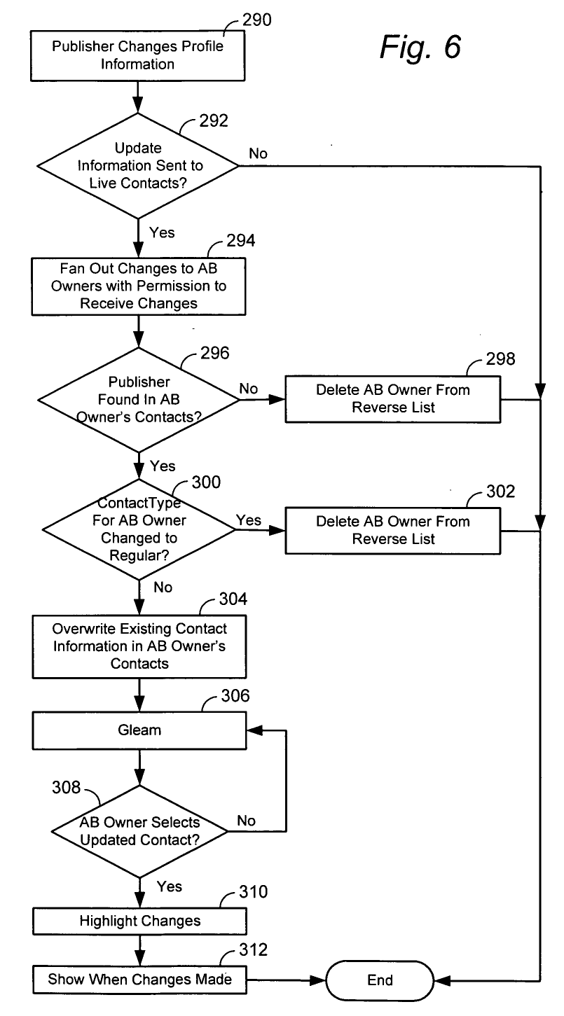

Referring now to FIG. 6, from time to time a publisher may choose to change the information in his or her profile in step 290. In step 292, the system checks whether the information changed is the type of information which is automatically updated in an AB owner's contacts. As indicated above, a publisher may have several sub-profiles in his or her profile, of which only personal information and professional information are automatically updated (in embodiments). If the change made to the publisher's profile in step 290 does not involve information that is disseminated with the automatic updates feature, then the updated information is not sent out to AB owners. However, if the information changed in step 290 is information that is automatically updated, the sub-profile including the changed information is sent out to those with permission to receive it in step 294.

In embodiments, when a change is made to a profile and saved, the sub-profile(s) including the changed information are pushed to the database server 110. When an AB owner then accesses his or her address book from the database server 110, the updated sub-profile(s) are sent to the AB owner. An AB owner may alternatively receive updated sub-profile(s) as soon as the updated sub-profile(s) are sent to the database server 110.

The updated sub-profile(s) are sent out to all recipients on the publisher's reverse list. However, it may happen that an AB owner has removed the publisher's contacts since the prior update. The system checks whether the publisher is found in an AB owner's contacts in step 296. If not, the AB owner is deleted from the publisher's reverse list in step 298.

While a publisher may remain in an AB owner's contacts, the AB owner may indicate that he or she no longer wishes to receive automatic updates from the publisher, and the status of ContactType has been changed to Regular. The system checks whether the ContactType for the AB owner has been changed to Regular in step 300, and if so, the AB owner is deleted from the publisher's reverse list in step 302.

Assuming the system locates contact information for the publisher in an AB owner's contacts, and the ContactType status for that AB owner remains Live, then the updated sub-profile(s) for the publisher is written over the previously existing sub-profile(s) in the AB owner's contacts in step 304.

The manner and degree to which information is written over upon an automatic update as described above may vary in alternative embodiments. In one embodiment, if a sub-profile is updated, then all mapped fields in the target contact are overwritten by the current sub-profile fields. In a further embodiment, only information which has changed relative to the last update is written into the AB owner's contact. In this embodiment, a timestamp for each update may be maintained. In a further embodiment, all mapped fields in the target contact are overwritten by the current values in the updated sub-profile (as described above), except where an updated field is null. In this case, the prior information in the field corresponding to the updated null field would remain for the publisher's contact.

In embodiments, existing contact information is automatically overwritten with updated contact information. However, it is contemplated in alternative embodiments, that an AB owner may be given the option to accept or decline updated contact information. An AB owner may also designate that certain information in their contacts for the publisher is not to be overwritten or changed upon an update. Such information may include notes that the AB owner has created for that contact.

Once the contact information is updated, the contact may gleam in step 306 to indicate there has been a change in contact information. As indicated above, the gleam may be any visual indicator designated to show a change in a contact. This gleam would generally be distinguishable from the gleam discussed above notifying an AB owner that one of their contacts has set up a profile. In step 308, the contact will continue to gleam until the AB owner selects the updated contact. If selected, the AB owner is shown what changes have been made, for example, by highlighting the changes (such as with field-level gleams) in step 310. The time at which the changes are made may also be indicated in step 312. Once the changes are viewed, the gleam which indicated the change may be removed. The time the contact was last changed, and the time the contact was last viewed are stored by the service provider on database 110 or elsewhere. Thus, if the time of the last viewing is after the time of the last change, the gleam indicating the change may be removed.

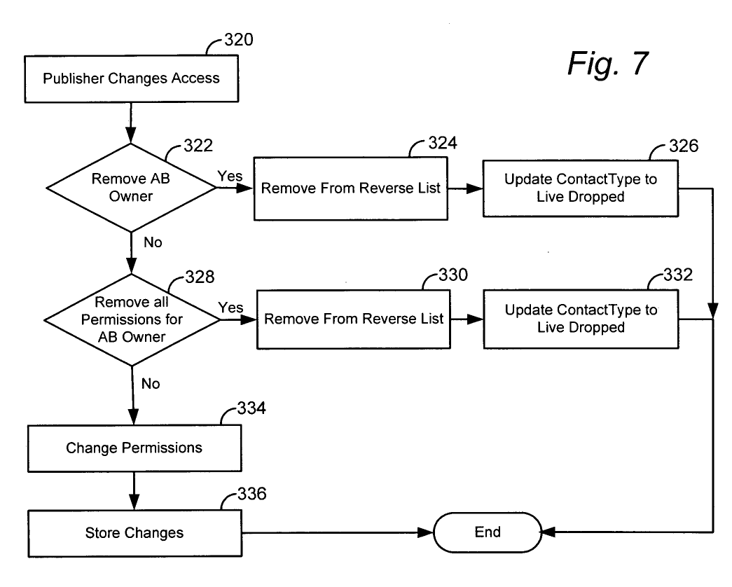

In addition to changing the content of a profile, a publisher may also change access privileges and permissions in a step 320 as shown in FIG. 7. In a step 322, the system checks whether the publisher has rescinded the automatic update feature for a particular AB owner. If so, that AB owner is removed from the publisher's reverse list in step 324, and the ContactType for that AB owner is changed to LiveDropped in step 326. If the publisher has not rescinded the automatic update but has instead removed all permissions for that AB owner in step 328, this has the same effect. The AB owner is removed from the publisher's reverse list in step 330, and the AB owner's ContactType is changed to “LiveDropped” in step 332

If a publisher has neither rescinded an automatic update nor removed all permissions for an AB owner, the permissions are changed in step 334 and those changes are stored in the database server 110 in step 336. Where an AB owner no longer has permission to receive certain information as a result of the change in permissions, that AB owner will no longer receive automatic updates of that information.

An AB owner who has not yet subscribed to automatic updates may still be shown changes to a publisher's profile. This may appear side-by-side with their existing information for the publisher. The AB owner may then be offered a link allowing the AB owner to subscribe to automatically receive updated information. As indicated above, an AB owner's contact information for a publisher may gleam even if the AB owner does not subscribe to automatic updates for the publisher. This may further prompt the AB owner to subscribe to the automatic updates feature of the present system.

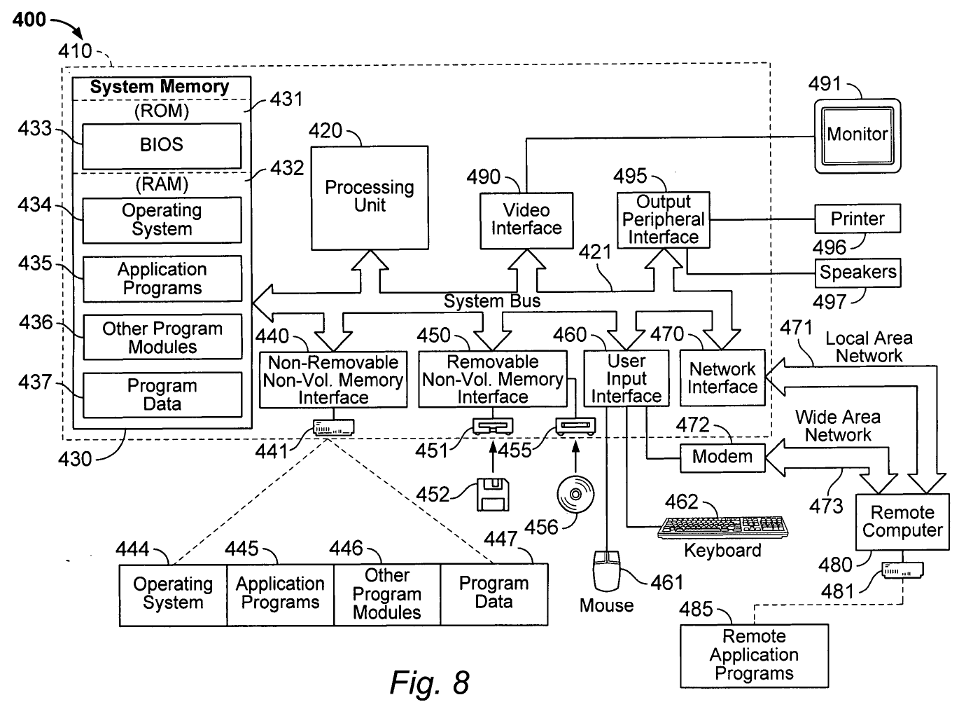

FIG. 8 illustrates an example of a suitable general computing system environment 400 that may comprise any processing device shown herein on which the inventive system may be implemented. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 8, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 8 illustrates operating system 434, application programs 435, other program modules 436, and program data 437.

The computer 410 may also include other removable/non-removable, volatile/nonvolatile computer storage media. By way of example only, FIG. 8 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440, magnetic disc drive 451 and optical media reading device 455 are typically connected to the system bus 421 by a removable memory interface, such as interface 450.

The drives and their associated computer storage media discussed above and illustrated in FIG. 8, provide storage of computer readable instructions, data structures, program modules and other data for the computer 410. In FIG. 8, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 8. The logical connections depicted in FIG. 8 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 8 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of automatically updating a contact for a first individual in an address book of a second individual, comprising the steps of:
(a) updating information in a stored profile for the first individual; and
(b) automatically updating the contact for the first individual in the address book of the second individual with the information updated in said step (a), the step (b) of automatically updating the contact for the first individual in address book of the second individual being performed at the server level.

2. A method as recited in claim 1, said step (a) of updating information on a stored profile comprising the step of updating a sub-profile in the profile relating to at least one of the first individual's business contact information and the first individual's personal contact information.

3. A method as recited in claim 1, said step (b) of automatically updating the contact for the first individual in the address book of the second individual comprising the step of updating the contact for the first individual based on updates made to the profile in said step (a) and permissions set by the first individual for what updates the second individual is to receive.

4. A method as recited in claim 1, further comprising the step of notifying the second individual with a visual indicator when the contact for the first individual is updated.

5. A method as recited in claim 1, said step (b) of automatically updating the contact for the first individual in the address book of the second individual comprising the step of updating the contact at the server level without an action required of the second individual.

6. A method as recited in claim 1, said step (b) of automatically updating the contact for the first individual in the address book of the second individual comprising the step of updating the contact at the server level upon acceptance of the update from the second individual.

7. A method of automatically updating a contact for a first individual in an address book of a second individual stored on a first database, comprising the steps of:
(a) storing a profile for the first individual on a second database;
(b) providing the option for the second individual to link the profile with the address book of the second individual; and
(c) changing the contact for the first individual in the address book of the second individual when changes in the profile occur, said step (c) of changing the contact for the first individual in the address book of the second individual being performed by a server in communication with the first and second databases.

8. A method as recited in claim 7, wherein said step (b) of linking the profile with the address book comprising the step of linking the profile with the address book upon identifying a relationship between the first individual and the second individual.

9. A method as recited in claim 8, wherein said step of identifying a relationship between the first and second individuals comprises the step of identifying the second individual on an allow list of the first individual.

10. A method as recited in claim 8, wherein said step of identifying a relationship between the first and second individuals comprises the step of at least one of: i) performing a matching process locating an existing contact, and ii) adding a new contact for the first individual in the address book of the second individual.

11. A method as recited in claim 7, further comprising the step of storing permissions, and wherein said step (c) includes determining changes to the contact based on said permissions.

12. A method as recited in claim 7, further comprising the step of including a first visual indicator on the contact after said step (a), the first visual indicator indicating the existence of the profile.

13. A method as recited in claim 12, further comprising the including a second visual indicator on the contact after said step (c), the second visual indicator indicating a change in the contact.

14. A method of a service provider automatically updating a contact for a first individual in an address book of a second individual, comprising the steps of:
(a) allowing the creations of a profile having contact information for the first individual;
(b) receiving a request for automatic updates of the profile from the second individual;
(c) determining whether the request is granted by the first individual; and
(d) automatically updating the second individual's address book with a modification made in the profile if the request is granted, said step (d) of automatically updating the second individual's address book with any mapped modification made in the profile be performed by a server of the service provider.

15. A method as recited in claim 14, further comprising the step of storing permissions, and wherein said step (c) includes determining updates based on said permissions.

16. A method as recited in claim 15, said step of storing permissions comprising the step of granting permission on one or more groups of subprofile information stored in the first individual's profile.

17. A method as recited in claim 1, wherein said step of granting permission on one or more categories of subprofile information stored in the first individual's profile comprises the step of granting permission on one or more categories including general information, professional contact information and personal contact information.

18. A method as recited in claim 14, further comprising the step of maintaining a status in the contact of whether the request made in said step (c) was granted or denied.

19. A method as recited in claim 14, said step (d) of receiving updates automatically recorded in the second individual's address book comprising the step of updating the contact without an action required of the second individual.

20. A method as recited in claim 14, said step (d) of receiving updates automatically recorded in the second individual's address book comprising the step of updating the contact upon acceptance of the update from the second individual.
